(19) United States
(12) Patent Application Publication
(10) Pub. No.: US 2022/0008999 A1
(43) Pub. Date: Jan. 13, 2022

(54) ADVANCED AUTOMATED FABRICATION UTILIZING LASER FABRICATION SYSTEM AND METHODS FOR AN AUTOMATED ROBOTICIZED FACTORY

(71) Applicant: Kevin Lee Friesth, Fort Dodge, IA (US)

(72) Inventor: Kevin Lee Friesth, Fort Dodge, IA (US)

(21) Appl. No.: 17/314,566

(22) Filed: May 7, 2021

Related U.S. Application Data
(60) Provisional application No. 63/022,053, filed on May 8, 2020.

(51) Int. Cl. B22F 12/41; B22F 12/49; B22F 10/28; B22F 10/85; B22F 12/50; B33Y 10/00; B33Y 40/00; B33Y 50/02

(52) U.S. Cl. CPC B22F 12/41; B22F 12/49; B22F 10/28; B33Y 50/02; B22F 12/50; B33Y 10/00; B33Y 40/00; B22F 10/85

(57) ABSTRACT

Provided are advanced automated fabrication methods and systems which utilize laser fabrication. Also provided are methods for an automated roboticized factory. The disclosed invention utilizes a number of modules to result in automatic fabrication, which provides advantages over manual fabrication of the prior art. Embodiments of the disclosed invention may include a material management module, a build module, an automation module, and a control module. Embodiments of the invention may employ artificial intelligence with machine learning such that the fabrication system becomes even more efficient and accurate over time.

This application claims priority from U.S. Provisional Application Ser. No. 63/022,053 filed May 8, 2020 and entitled ADVANCED AUTOMATED FABRICATION UTILIZING LASER FABRICATION SYSTEM AND METHODS FOR AN AUTOMATED ROBOTICIZED FACTORY. The entire contents of U.S. Provisional Application Ser. No. 63/022,053 are hereby incorporated in its entirety by reference.

### FIELD OF THE INVENTION

Disclosed is a fabrication system utilizing automated 3D manufacturing. Illustrative embodiments include an “End to End” integrated automated and roboticized hybrid fabrication system for any metal or plastic object.

### BACKGROUND

Additive Manufacturing (AM) technology is revolutionizing the ways products are conceptualized, developed, and realized. For electronics and electrical medical devices, AM or 3D printing can improve time to market, streamline logistics, eliminate single suppliers, and reduce inventory while meeting customer and regulation demands.

In the past Direct Metal Deposition was typically referred to as Laser Cladding since it can be used to add a certain amount of metal in order to repair a damaged or worn part. With the expansion of 3D printing technologies to create near end-use parts, this technology is then also used as a way to create from the ground an entire object and in the preferred method of the present invention integrated to enhance quadratic HDLS technology greatly surpassing prior art in speed and quality of fabrication yet providing real time alteration and repair during the initial build and additionally as follow-up during the CNC process. Then, the substrate is no longer just a part to be repaired but a platform to start building or alter an existing build part.

A laser spray nozzle assembly is described in U.S. Pat. No. 4,724,299. The assembly includes a nozzle body with first and second spaced apart end portions. A housing, spaced from the second end portion, forms an annular passage. A cladding powder supply system is operably associated with the passage for supplying cladding powder thereto so that the powder exits the opening coaxial with a laser beam.

Typical metal 3D printing technologies (selective laser melting, direct metal laser sintering, direct metal deposition laser sintering), these technologies are based on the premise of transformation of powdered and/or wire and/or cord in metal and nonmetal materials into a solid metallic object. The main principle is to use a powder or wire feed nozzle then using the shielding gas or in the case of wire or cord using friction propulsion to propel the material into the laser beam.

The material is then fused by the laser. Using a layer by layer strategy, the printer head and/or power deposition duct head, comprised of the laser beam and the feed nozzle, can scan the substrate to deposit successive layers. The deposit width is between 0.5 to 2.5 mm while the layer thickness lies between 0.1 and 0.85 mm with wire up to about 2.5 mm.

Additive manufacturing processes for metal sintering or melting (such as selective laser sintering, direct metal laser sintering, and selective laser melting) usually went by their own individual names in the 1980s and 1990s. At the time, nearly all metal working was produced by casting, fabrication, stamping, and machining; although plenty of automation was applied to those technologies (such as by robot welding and CNC), the idea of a tool or head moving through a 3D work envelope transforming a mass of raw material into a desired shape layer by layer was associated by most people only with processes that removed metal (rather than adding it), such as CNC milling, CNC lathe, CNC EDM, and many others.

Direct Metal Deposition is an additive manufacturing technology using a laser to melt metallic and nonmetallic powder or wire. Unlike most of the other technologies, it is not based on a powder bed but it uses a feed nozzle or friction system to propel the material into the laser beam. It is very similar to Fused Deposition Modeling as the nozzle can move to deposit the fused metal.

Direct Metal Deposition, the laser beams and the material being fused are focused and scan the substrate to deposit the material. This technology can be used in various industries such as in the thermal or mechanical related component usage field to repair complex and expensive parts instead of replacing them. That way, the manufacturer saves a spare part and the cost of disassembly and reassembly.

However, prior art systems and methods have drawbacks, beginning in the initial raw and/or recycled materials stage. For example, during melting and the follow-up processing typically all material, whether material formed stock or powders, are exposed to oxidation and moisture which thereby if not removed contaminate all follow up processes. Moreover, prior art fabrication deficiencies continue through the remaining, isolated processes from exposure to the atmosphere resulting in oxidation and moisture contaminants.

Prior art deficiencies continue through fabrication with isolated thermal management processes. For example, thermal management and heat treatment methods and applications are lacking in the ability to control and/or maintain thermal management of fabrication temperatures to maintain at or near lower critical material temperatures throughout the entire fabrication process. This results in lower quality of material properties from thermal related material anomalies and/or consequences thereof.

Further drawbacks include lack of affordable finalization processes such as heat treat processes, for example with precipitation and tempering. This drives up the cost of the processes. Moreover, lack of automated processes for finalizing fabrications increases costs, which is driven by part concentration of loose components, lack of automated stacking and robotic handling systems, lack of scale of heat treatment machines, machine costs into the millions of dollars, and a limited thermal cycle lifespan thereby adding an even higher premium for the isostatic process per unit fabrication cost.

Moreover, prior art fabrication deficiencies include the lack of automation, for example in the finalization processes and isostatic processes with machines that lack cost effective scaling capabilities, are expensive, and have a limited thermal cycle lifespan thereby adding an even higher premium for the isostatic process cost.

Another prior art fabrication deficiency is the use and/or lack of inclusion of containment gases. Attention to direct and indirect issues such as solubility and thermal conductivity caused material characteristic property losses and deficiencies. For example, the use of nitrogen in prior art additive manufacturing and primarily in conventional metal fabrications was used for surface hardening. Although nitrogen is a cheap containment gas, it has several serious side effects and long-standing consequences. When polymers and/or metals are used with DMLS 3D printers and/or SLS 3D printers, each layer becomes a surface. Accordingly, each layer has the laser melts and/or sinters, which enhance the absorbency of the material, causing nitriding effects including gas voids or nitrogen networks within the material layers. This problem worsens when trapped gases are sealed into thermal stress micro fractures or voids sealed within the material layers.

Prior art fabrication also doesn't always fully remove, or close all voids or thermal stress micro fractures, even with the use of iso static pressing. This is at least partially because the prior art systems cannot remove gas pockets from within an enclosed area in a void or dwelling in a micro fracture occupying some of the crack's available space.

Another drawback of prior art fabrication is the utilization of differing control systems, control hardware, communication methods, standards, operation, and typical design for manual operation with human operators, as well as human involved handling processes. These prior art systems are, therefore, not intended or designed for automation.

Prior art fabrication is limited in material choices, machinability, fabrication methods, methods, or limited scaling of the application. In addition, prior art methods typically utilize excessive material produce excessive fabrication waste, and require excessive labor and energy usage, while having lower efficiency and lower capabilities. Additionally, prior art fabrications and manufacturing methods and applications suffer from reduced quality and limited characteristics or reduced characteristics due to changes in the material's structural composition and properties matrix. For example, prior art fabrication and manufacturing methods typically alter the coefficient of thermal expansion, thereby the materials do not exactly match thermal expansion rates which causes the material properties to break down and separate in the form of thermal stress micro fractures, cracks and material fatigue, such as bending or bowing in the material and other non-optimal conditions.

In another example, prior art heat exchangers have basic designs that utilize tube and shell designs which suffer from low effectiveness, large material usage, non-optimal surface area density, very large foot print, high weight, transportation and handling issues. In yet another example, prior art plate heat exchangers (PHE) suffer from lower effectiveness, non-optimal surface area density, lower pressure limitations, lower temperature limitations, high manufacturing cost, and special order typically requiring very lead times for delivery. Moreover, another prior art system, such as the 1980's printed circuit heat exchanger (PCHE)'s, usage of diffusion bonding technology utilizes etching processes such as acid etching, electrical discharge machining (EDM) or laser etching to remove material to form channels within the base material and uses another process for diffusion of the target materials with use of a second material for diffusion bonding. Etching limitations however also limits the shape and complexity of the pathways channel being etched which is slow. Therefore, speed of fabrication increases costs dramatically.

Lastly, fused and/or diffusion bonded areas are exposing the dissimilar material to differing coefficients of expansion, which results in issues caused from the dissimilar materials that are used for the fusing and/or diffusion bonding. PCHE also suffers from low effectiveness and non-optimal surface area density, thereby lowering efficiency and incurring higher material usage, generates scape. The process exhibits mass production limitations. It is a time consuming and costly multiple step processes that requires higher preparation and fabrication costs, excessive design and labor costs, and lengthy lead times for delivery.

### SUMMARY

Provided is a modular system for automated fabrication comprising a material management module, a build module which includes a 3D printing module, an automation module, and a control module for integrating the modules with each other. The 3D printing module may be a hybrid direct laser sintering process, which may include a select laser sintering module and a quadratic direct metal laser sintering module. It may include at least one scanner, which may be one or more of a 3D object scanner, thermal scanner, and a visual scanner. The material management module may manage at least one of new material, recycled material, and waste material, or all three. The control module may be a cloud-based system and may include monitor, analysis, and/or accounting modules.

The system may include an artificial intelligence module. In some embodiments, two or more system located across a geographic distance may contribute to a single machine learning module of the artificial intelligence module.

The build module may include at least one of a heater, insulation, and a water jacket. The system may utilize a self-contained cartridge system. It may further include one or more of a mechanical lift system, vacuum ducting, gas supply ducting, and a material capture tray.

The system may include a finite element analysis module. Moreover, the system may include a recoater module.

The system may include one or more computers connected to each module. The one or more computers may communicate with each other to make up the control module.

### BRIEF DESCRIPTION OF THE DRAWINGS

FIG. 1 is a schematic of an automated 3D fabrication factory implementing methods and systems of the present invention.

FIG. 2. is a schematic of a second embodiment of an automated 3D mass fabrication factory implementing methods and systems of the present invention.

FIG. 3 is a schematic of an embodiment of a quad laser assembly of the present invention.

FIG. 4 is a schematic of an embodiment of gas and cooling cycles of the present invention.

FIG. 5 is a schematic of an embodiment of a build chamber of the present invention.

FIG. 6 is another schematic of a build chamber of the present invention.

FIG. 7 is yet another schematic of a build chamber of the present invention.

FIG. 8 is a schematic of an embodiment of material melting, transfer, separation, and processing of the present invention.

FIG. 9 is a schematic of an embodiment of an HDLS system vacuum powered powder pump material supply and vacuum feeder system of the present invention.

FIG. 10 is a schematic of an embodiment of the present invention utilizing an ultrasonic imaging and leveling module.

FIG. 11 is a second schematic of an embodiment of the present invention utilizing an ultrasonic imaging and leveling module.

### DETAILED DESCRIPTION

Provided are an advanced automated fabrication system utilizing laser fabrication and a method for an automated roboticized factory. As discussed above, fabrication systems of the prior art are flawed. The inventive system and method improve upon 3D printing systems of the prior art by fully automating the fabrication system. Preferred embodiments of the invention utilize modules or modulization of one or more components to create a fully automated fabrication system. Systems and methods of the present invention are applicable across myriad industries where things must be fabricated or manufactured, including but not limited to plastic items, metal items, and resin items.

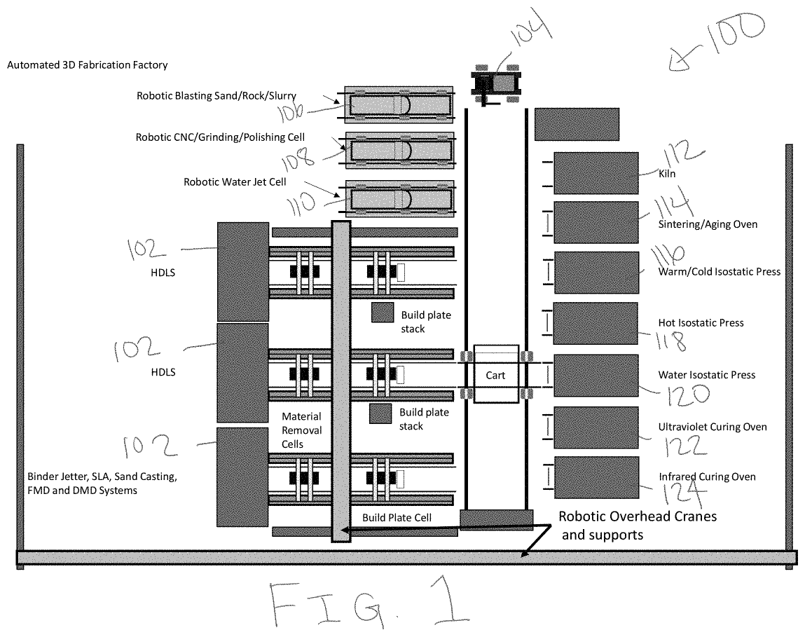

Referring to FIG. 1 a schematic of a first embodiment of a system 100 of the present invention providing a fully automated fabrication factory is shown. Systems of the present invention include one or more modules. The illustrated embodiment includes several modules. The system includes one or more HDLS printers 102. A cart 104 is provided to transfer items in fabrication between modules. Other modules within the illustrated system include a robotic blasting sand/rock slurry module 106, robotic CNC/grinding/polishing cell module 108, robotic water jet cell module 110, kiln module 112, sintering/aging oven module 114, warm/cold isostatic press module 116, hot isostatic press module 118, water isostatic press module 120, ultraviolet curing oven module 122, and infrared curing oven module 124. The cart 104 is able to move material to be fabricated to the various modules before, during, and after fabrication. In addition, robotic overhead cranes and supports may be utilized.

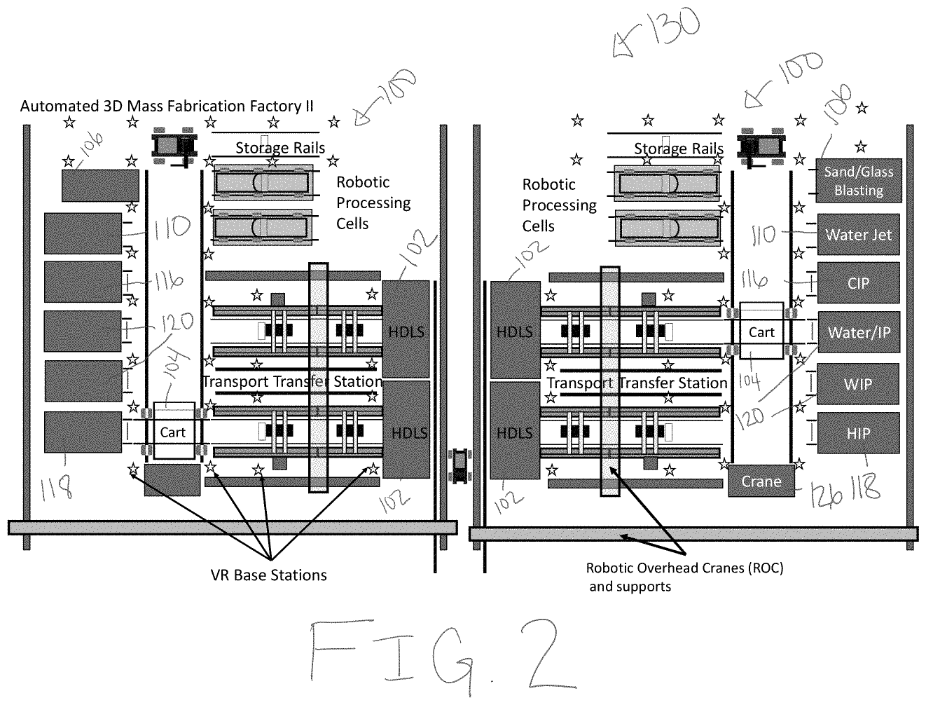

Referring now to FIG. 2, a schematic of another embodiment of a system 130 of the present invention providing a fully automated 3D mass fabrication factory is shown. Like the first embodiment, a cart 104 is used to transport material/product between a plurality of modules. The modules include HDLS printers 102, a sand/glass blasting module 106, at least one water jet module 108, a cold isostatic press module 116, a plurality of water isostatic press modules 120, and a hot isostatic press module 118. A crane 126 is used to assist in movement of objects between modules. In this embodiment of the system 100 a plurality of fabrication systems 100 are employed to increase fabrication capacity.

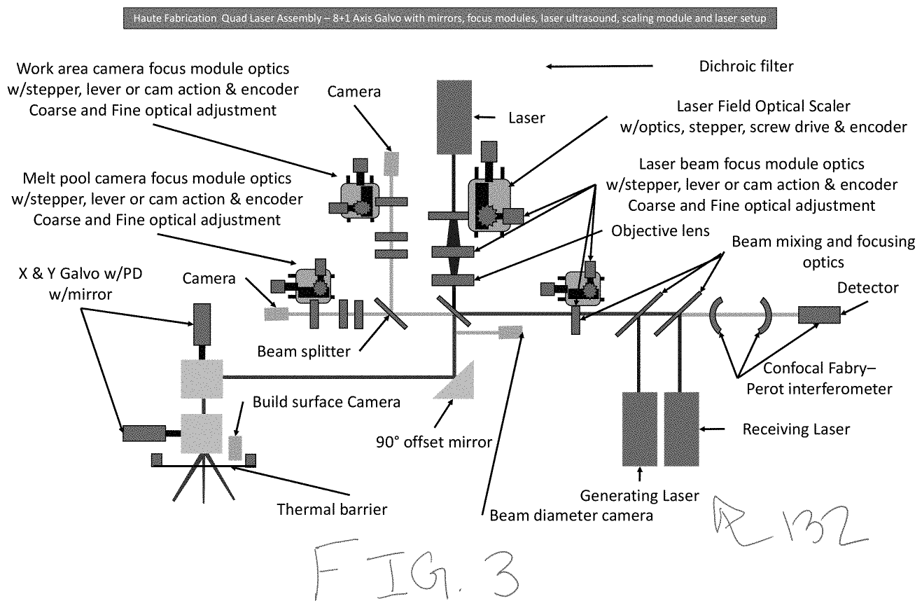

As will be discussed in further detail below, systems of the present invention may utilize one or more lasers. Preferably, the one or more lasers may be a galvo laser. A system 132 of a galvo laser is provided in FIG. 3.

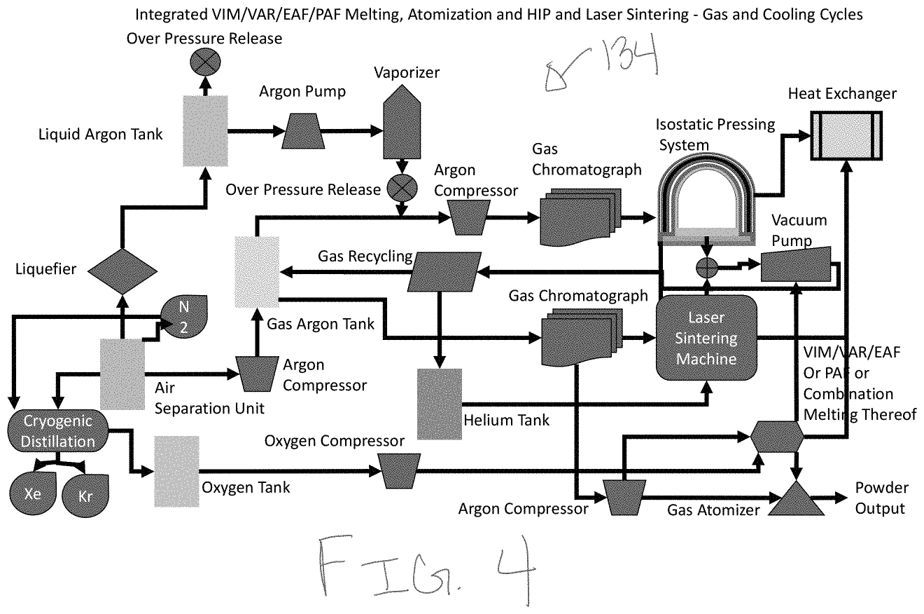

In addition, as will be discussed in further detail below, systems and methods of the present invention include containment gas, such as in cooling cycles. A schematic 134 describing an embodiment of same is provided in FIG. 4.

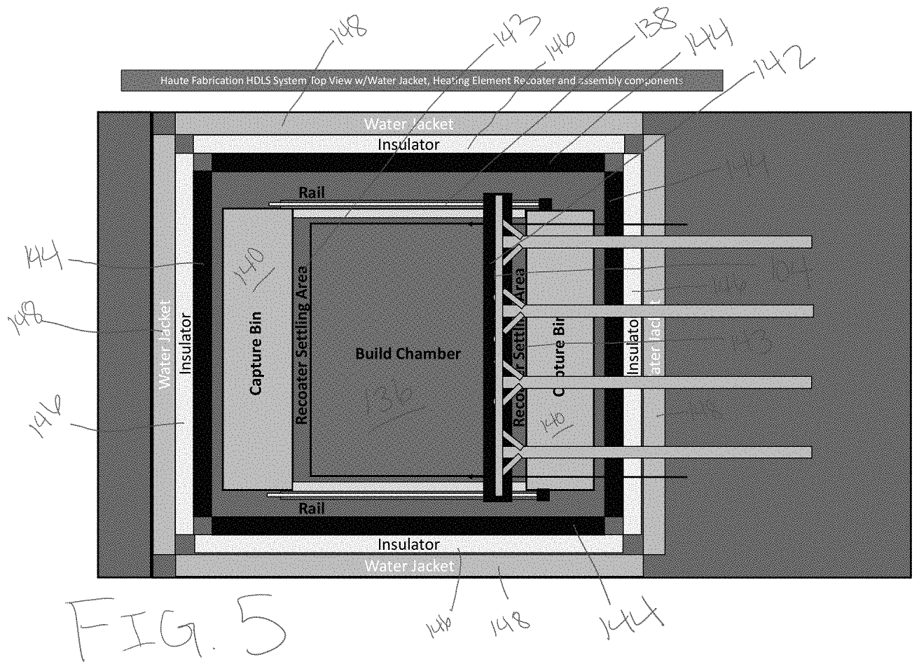

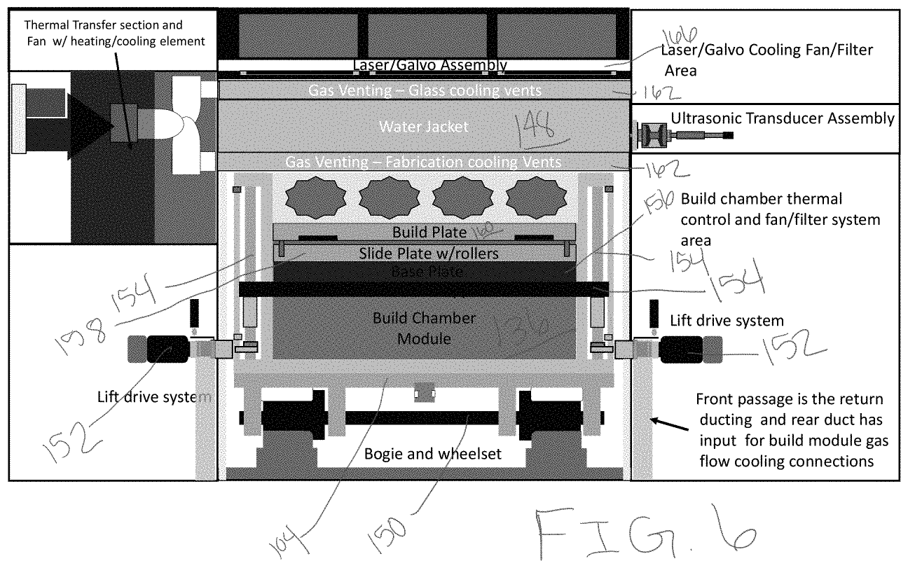

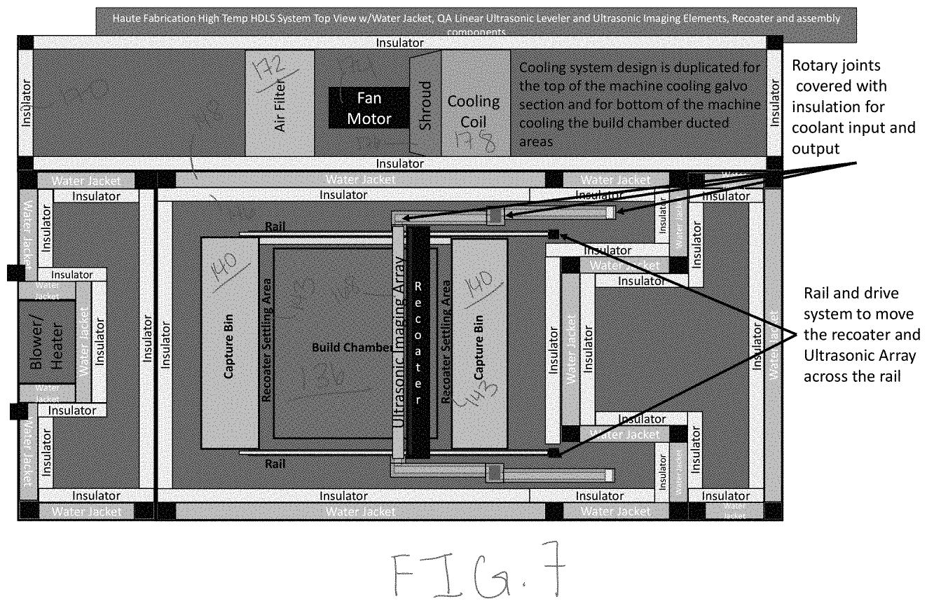

Turning now to FIG. 5, an example of an embodiment of a build chamber 136 of the present invention is shown. The build chamber 136 may include a rail 138 on which the cart 104 may travel. The build chamber 136 may be flanked by one or more capture bins 140. The build chamber 136 may also include a recoater 142, which will be described in detail, and which may work in conjunction with a recoater settling area 143. The build chamber 136 may be surrounded by a heating element 144, an insulator 146, and a water jacket 148. FIG. 6 shows another view, specifically a side view, of a build chamber 136 of the present invention. Shown are the bogie and wheelset 150 of the cart 104, which also includes a lift drive system 152. The build chamber module includes supports 154. Also included are a base plate 156, side plate with rollers 158, and the build plate 160, which is described in further detail below. Some embodiments of build chambers 136 may include gas venting 162 for fabrication cooling. Also shown is the water jacket 148 and further gas venting 164 for glass cooling. The laser/galvo assembly 166 is located at the top of the build chamber. FIG. 7 illustrates yet another embodiment of the build chamber 136, which adds an ultrasonic imaging array 168 to the system. Also added is a second insulation 170 system including an air filter 172, fan motor 174, shroud 176, and a cooling coil 178.

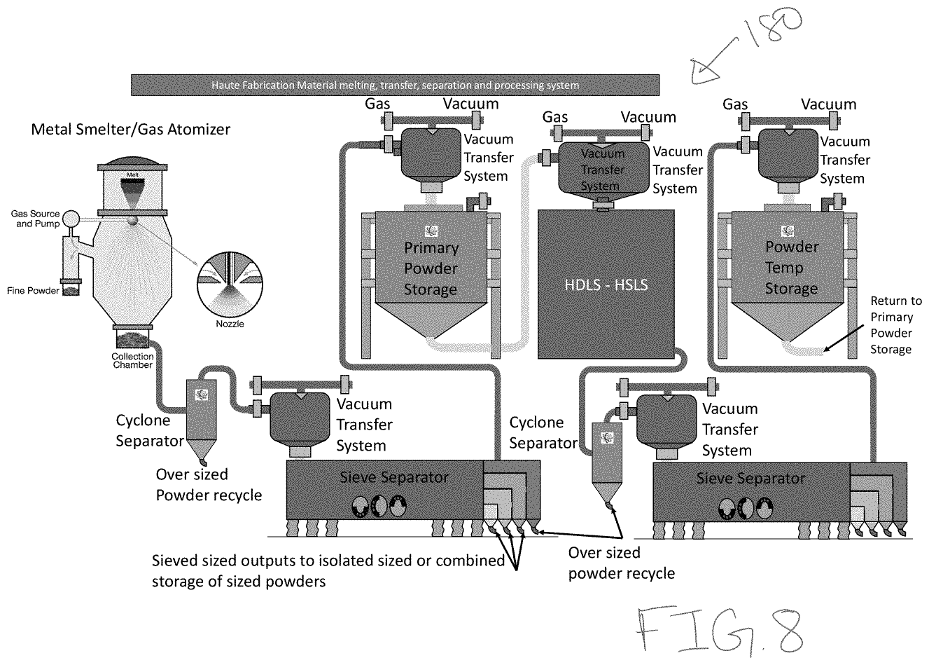

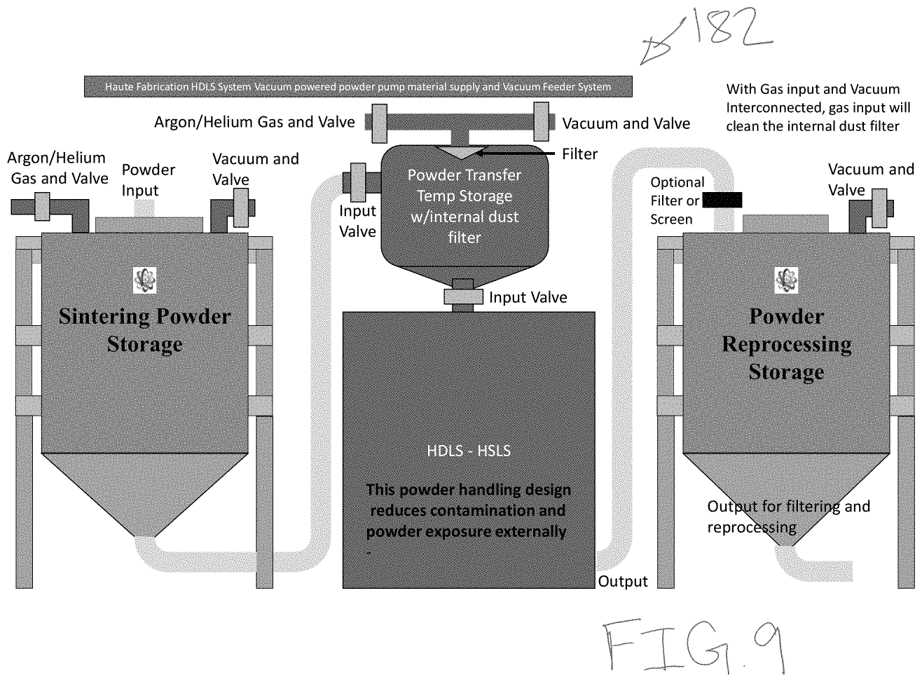

FIGS. 8 and 9 illustrate embodiments of material management within the system. FIG. 8 shows a first schematic 180 of material management, while FIG. 9 shows a second schematic 182 of material management.

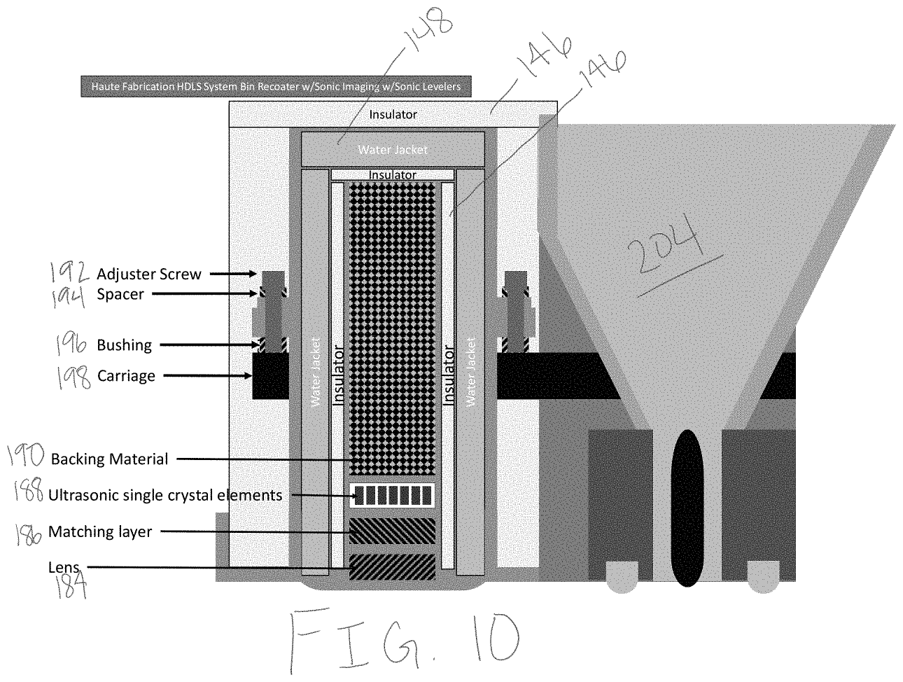

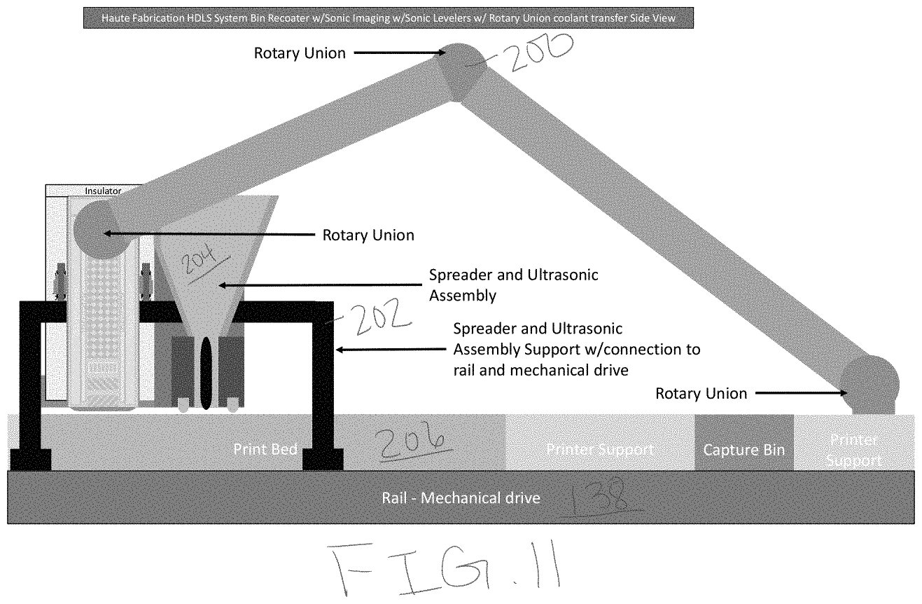

Lastly, FIGS. 10 and 11 provide embodiments of the present invention utilizing an ultrasonic imaging and leveling module. FIG. 10 shows two insulators 146 and the water jacket 148. Also shown are a lens 184, matching layer 186, ultrasonic single crystal elements 188, and backing material 190. The illustrated embodiment includes an adjuster screw 192, spacer 194, bushing 196, and carriage 198. FIG. 11 shows how the ultrasonic imaging and leveling module fits within the overall fabrication system. Shown is a rotary union 200. A support 202 supports the spreader and ultrasonic assembly 204. The support is connected to the print bed 206. The cart 104 may move on the rail 138 to bring materials in fabrication to this module.

The preferred method of the present invention will generally utilize a distributable cloud-based control system for monitoring, analysis, simulation, accounting and control. Preferably, the system typically will be operated by artificial intelligence through learned data and initial data presets. The preferred method of the present invention will generally utilize three independent systems to allow independent operational control, operational analysis, and operational accounting. The preferred method of the present invention will generally use a cloud based artificial intelligence and machine learning system to quantify and optimize the overall system and each system under its management with a unified cloud-based system.

The preferred method of the present invention provides for an end-to-end material metering and tracking system, which may include a weighing system for starting material, such as new material or recycled material input for melting. Further included are vacuum transfer for the following: to separation and storage, metered input into the system, transfer into fabrication machines, from fabrications to separation, to metering input system, and transfer to storage. The preferred method of the present invention can work with the previous method to transfer data from each process to enable inventory management and automated material tracking.

The preferred method of the present invention will generally utilize a unified software and hardware control system for additive manufacturing, robotics and process automation, for example CNC Lathe, CNC Mill, CNC Bender, CNC Cutters (Laser, Water Jet, Plasma), CNC Pick and Place, CNC Crane Systems and similar automated systems.

The preferred method of the present invention may utilize argon gas as the containment gas for stereolithography. This avoids the prior art tendency to allow exposure to atmospheric gases, which promotes oxidation of every layer. Utilizing argon reduces oxidized layered material within the fabrication, which is advantageous. This has greater bearing with transparent and semi-transparent fabrication. Once disadvantage to Argon is that it is a poor thermal conductor, similar in efficiency to nitrogen or event atmospheric air (which is mostly Nitrogen). To solve this problem, the preferred method of the present invention also uses helium, which is another noble gas and has eight times the thermal conductivity of argon gas by itself. A mixture of the two gases will result in a gas mixture in which the gas mixture allows for containment gas utilization but with higher thermal conductivity for thermal management. Furthermore, such a gas mixture is typically less expensive. The preferred method of the present invention assists in maintaining temperature normalization for accurate thermal management and reduction of “hot spots” of variable temperatures throughout the fabrication system and directly in the vicinity of the area that materials are being fabricated. The preferred method of the present invention assists in thermal exchange whether attempting to lower the operating temperature or inserting thermal energy to increase the operating environment temperature. The preferred method of the present invention provides enhanced thermal management over prior art through a higher thermal conductive gas mixture. These gases remain in the system after fabrication cycle completion and then can be vacuumed out of the system, processed, contaminants removed, and then reused for the next cycle, perhaps only needing a small addition of new replacement gas input.

The preferred method of the present invention is symbolized as “Manufacturing As Symbiotic Service (MaSS)”. The invention is based on an automated and roboticized “End to End” fabrication system that integrates the following processes: incorporating the raw and/or recycled material management, material processing, HDLS system design in a hybrid amalgamation of additive, conventional fabrication hardware, and automation integrating collaborative robotic processes and handling. Systems and methods of the present invention are supported by an all-encompassing software platform solution, employing a cloud based monitor, analysis, accounting and control system with artificial intelligence and machine learning.

The preferred method of the present invention integrates design for manufacturing, design for additive manufacturing, and design for assembly into a single control system and single manufacturing philosophy. The preferred method of the present invention further integrates additional 3D additive manufacturing such as binder jetting, 3d sand casting, FDM and others. The preferred method of the present invention includes a cloud-based control software that enables its utilization with all types of 3D printing, including but not limited to, SLS, DMLS, Multi-Axis DMD, Multi-Axis EBM, FDM, SLA, FDM, Binder Jetting, 3D Sand Casting, CNC methods and EDM machining, Plasma spray, biomedical 3D printers, and robotic automation of other conventional fabrication methods.

The system utilizes Specialized Manufacturing using Advanced Robotics Technology (SMART) commonly referred to as Automated Manufacturing Technology (AMT). Accordingly, the invention provides a robust next generation integrated fabrication and manufacturing solution, providing a formidable go-to source for one-off production, contract on demand mass fabrication, and manufacturing offering design for manufacturing with design for assembly.

The preferred method of the present invention provides for fabrication builds offering a wide choice of materials while maintaining material characteristics before, during and after fabrication. The method of the present invention also allows for highly complex geometries with the ability to monitor, analyze and repair surface errors and voids, multiple material build components or utilization of integrated fabrication technologies.

Various prior art methods and systems generally utilized isolated fabrication methods and processes, such as TIG and MIG welding, brazing, casting, select laser sintering (SLS), direct metal laser sintering (DMLS), fused and diffusion welding and mechanical joints to fabricate and join materials. In each case prior art by default generally introduced additional material weakness from the fabrication method, failure points and reduced the maximum characteristics of the chosen materials to mere percentages of the original capabilities and many suffered from the completed project having inferior material density, scaling issues and lack of uniformity and no repair capability during build causing errors to be encased in the finished product which is common in prior art SLS and/or DMLS methods, casting with its channel and complex geometry shape limitations and mechanical joints limitations which are well known in prior art. Various pressure doors and methods are in prior art. Typical fusion welding typically involves joining two separate fabricated items but as such typically damages the initial material characteristics that changes the molecular structure at the point of joint and generally the nearby area from thermal stress and changing fundamental properties and characteristics. These phenomena are a result of the physical and chemical behavior of the inter-material properties of both metallic and nonmetallic components.

Thermal energy from typical prior art methods such as common fusion welding applications affects the joining material and the fusion weld itself. For example, joining stainless steel pieces changes the amount of chromium near the fusion weld due to the thermal energy attracting elements of chromium to the weld area. This reduces the quality and resistances of the base material from the material characteristics that are remaining after the joined material reverts back to its initial temperature.

The preferred method of the present invention provides methods for mass fabrications that can accommodate phase changes on any loops of the thermal component or heat exchanger. For example, some common thermal applications include closed loop cooling exchangers, lube oil coolers, gland steam condensers, low-pressure or high-pressure feed water heaters.

Further examples of additional common thermal applications are normal and high pressure and supercritical boiler, blowdown heat recovery exchangers, condensers, and evaporators.

In prior art processes, when dissimilar metals are exposed to electrolytic fluids, a process called galvanic corrosion (also called ‘dissimilar metal corrosion’ or sometimes referred to wrongly as ‘electrolysis’) occurs. Galvanic corrosion refers to corrosion damage induced when two dissimilar materials are coupled in a corrosive electrolyte environment which causes erosion and corrosion of the channels and pathways of the component, thereby shortening expected component lifespans while increasing maintenance and directly contributing to a component's partial and critical failures.

The preferred method of the present invention addresses galvanic corrosion by utilizing quadratic HDLS and strategically locating an access port for insertion of a ‘sacrificial anode’ within build designs to minimize the issue. The preferred method of the present invention utilizing quadratic HDLS fabrication provides the capability of advanced zig zag patterns and rounded zig zag patterns at scale and increases surface area to reduce pinch points and unnecessary cavitation within the channels while increasing potential flow characteristics and enhanced thermal effectiveness. An example of this occurs when ships use seawater for cooling intake seawater into a heat exchanger to remove thermal energy, which will cause erosion and corrosion of the heat exchanger, causing premature leaks and failures. This can also occur whenever water as a substance is exposed to contaminants that when mixed form a type of electrolyte. Once this occurs this will then allow current to flow through the solution when dissolved in water. Electrolytes promote low voltage current flow due to the fact they produce positive and negative ions when dissolved. The low voltage current flows through the solution in the form of positive ions (cations) moving toward the negative electrode and negative ion (anions) moving the positive electrode.

Unlike erosion, which is the physical degradation of a material due to the flow of water, wind, or debris, corrosion is the degradation of a material caused by chemical reactions. Corrosion affects many types of materials, including metals that are used in our daily processes and applications. Salt and polluted water is generally regarded as a more serious breeding ground for aggressive corrosion as the salt and pollution makes the water more conductive; however, it should be noted that polluted fresh water can be even more conductive than sea water with the right combination of electrolytic contaminants.

Corrosion in ducts and channels can advance into the interior parts of the component over time, which tends to lead to ducts and channel thinning and eventually ducts and channel failure if left untreated and typically unchecked within closed components. Furthermore, corrosion by-products are often carried downstream in piping, which can contaminate the fluid, cause the erosion and further corrosion of piping, and clog valve orifices yet the cause for additional leaks and failures.

These prior art methods and applications and methods introduce new points of failure, potential faults, and limitations, while greatly increasing material requirements, and, thereby, costs compared to the efficient method and process of the present invention. These prior art methods and applications and methods result in inability to scale fabrication build area, reduced material density from singular laser usage, lack of repair capability, and lack of mission critical quality assurance integration.

The preferred method of the present invention provides fabrication which in essence generates little or no waste during material fabrication, greatly reducing material usage and, therefore, material costs. The additional benefit is the environmental nature for reduction of energy usage attached to fabrication and processing of the material.

These examples expose the advantages of Hybrid Direct Laser Sintering and the need for automated processes in a single solution to optimize cost controls required for mass production. The preferred method of the present invention employs technology known as High Density Laser Sintering or Hybrid Direct Laser Sintering (HDLS), which primarily combines capabilities of both SLS and DMLS with post process automation and CNC enabled finishing processes. The preferred method of the present invention utilizes quadratic HDLS fabrication, providing for localized gas and thermal input for a superior advantage over prior art. It also provides a reduction in the fabricated component's overall footprint, volume and weight, by up to 95% depending on the application and component requirements. The preferred method of the present invention with quadratic HDLS fabrication provides for localized gas and thermal input for a superior advantage over prior art processes in thermal management. Quadratic HDLS provides the additional advantages within the gas flow and thermal movement, providing a reduction of blockage from contamination smoke and gases between the laser and the material caused by the lasing of materials.

The preferred method of the present invention utilizes purification of gases to promote use of optimized containment gases and removal of contaminated gases. The preferred method of the present invention utilizes cyclone separation and sieve screening of powered material to promote optimal sizing while removing oversized and slag from previous build cycles.

The preferred method of the present invention includes integration of quadratic High Density Laser Sintering (HDLS) having both select laser sintering (SLS) and quadratic direct metal laser sintering (DMLS) with an integrated 3D object scanner, thermal and visual camera scanning for monitor, analysis and control. Together, these features provide near zero defect fabrication, unavailable and unobtainable with prior art methods and applications.

In some embodiments of the present invention, the methods and systems allow for active analysis of 3D object scanning, thermal and visual analysis of the active object build and original 3D design to maintain constant monitoring, analysis, and control with observation and repair of anomalies. The integration of artificial intelligence and machine learning allows the machine to advance its abilities with and through each fabrication build process.

The present invention then allows the object build process to detect any visible, thermal or scanned faults and flaws and allow them to be repaired via laser remelting or allow a decision gate before a fault is allowed or over-looked and left in the build resulting in a flawed output or worse permeate into additional flaws and faults within the object build as faults and flaws would naturally occur in prior art.

The present invention, through use and integration of artificial intelligence and machine learning based on cloud integration, allows a single machine or multiple machines spread over a vast geography to learn and advance from each and every fabrication build cycle.

The preferred method of the present invention may utilize heater and/or insulation and/or include a water jacket in the machine surrounding the build module to moderate thermal energy transfer from the build module area and the rest of the machine. The preferred method of the present invention includes the use of rail and carriage or various prior art transport system to enable the heavy build module capacities and promote quick removal and installation of the build module to promote mass production.

The preferred method of the present invention includes the use of a self-contained cartridge system. In addition, a mechanical lift system, vacuum and/or gas supply ducting, and/or material capture tray may be connected as an add-on. The self-contained cartridge system may include a solid plate, solid plate with holes, or a mesh build plate to promote gas flow and thermal management. Material supply cartridges may be emptied or filled external to the machine to maximize operational builds via no excessive waits or machine downtime for removal or installation of cartridges for new builds. The preferred method of the present invention allows build modules to have the transfer plate and the build plate removed to maximize operational builds via no excessive waits or machine downtime for removal or installation of cartridges for new builds.

The preferred robotic work cells and cnc water jet work areas allow for material removal, which allows separation of the build object extraction for processing, handling and finishing.

The preferred method of the present invention uses robotic and automated processes for build plate insertion into/onto build modules.

The preferred method of the present invention uses an enclosed vacuum transfer of materials from material that has been melted and gas atomized powders to cyclone separation of large material rejects and transfer of acceptable sized powder material to sieve separation and vacuum transferred to storage This is the supply used to feed the HDLS machines.

The preferred method of the present invention allows variable adjustment for slicing generate layers for initial raft between the build platform and the initial row of fabrications.

Materials typically never have completely pure uncontaminated elements; generally, there are at least element impurities such as a carbon element contamination. Generally, materials have the similar characteristics, though accepted standards that allow variations of various elements at various concentrations for a chosen material. Elemental variances will generally produce desirable properties, but will affect laser absorption and reflectivity. This causes a chain reaction affecting melt temperature, which then affects the speed at which a material melts in response to optimal operational parameters in regards to the material composition of element concentrations.

The preferred method of the present invention utilizes finite element analysis, physics simulation and artificial intelligence to optimize a control system and its operations through additional response to data from a control feedback system, such as utilizing feedback to control states or outputs integral to a self-adaptive artificial intelligence controlled system. Feedback for example may consist of forward feedback, and reverse feedback. The preferred method of the present invention utilizes this feedback for optimization of thermal management with crucial temperature bands above lower critical temperatures to reduce or eliminate thermal stress micro-fractures and material weaknesses from material changes caused by uncontrolled rapid material cooling.

The preferred method of the presenting invention integrates ultrasonic leveling and ultrasonic imaging as a unified function.

The preferred method of the present invention includes a self-adaptive artificial intelligence control system for intelligent parameter optimization utilizing historical data comparison with correct active scans with imaging comparison with fabrication 2D slice data and 3D finite element analysis with physics simulation comparison with thermography analysis resulting in optimal self-adaptive operating parameters for ultimate fabrication quality output. The preferred method of the present invention utilizes Artificial intelligence to derive an Optimal Parameter Selection (OPS) system for the laser fabrication processes. The preferred method of the present invention utilized an OPS system that can capture the causal and inferential knowledge about current fabrication material and the relationships between the process parameters and resulting properties to provide material expert-level optimal recommendations during the parameter selection process. One OPS system purpose is to establish material-specific optimized parameters. Accomplishing this requires developing a library of each material's optimal operating parameters and updating each individually based on concentration levels of a specific material, and in some embodiments concentration levels of specific elements. The preferred method of the present invention offers building such a parameter optimization library model so as to control the quality of the final part and cater optimized operating parameters to different requirements of the specific material and by direct choice of the project. By adjusting an identified set of process parameters of a specific material, the quality of the laser-fabricated component can be accurately controlled for the intended result.

Prior art systems and methods all lack thermal management control to enable and maintain lower critical temperatures which allows the rapid cooling and unmanaged thermal changes during material recrystallization causing varying expansion and contraction of different elements ending in voids, tears and micro-fractures. Additionally, deficiencies from the contractions and expansions for the differing elements melting and crystallization temperatures creates voids, tears, thermal stress micro-fractures, and thermal build up that all has to be handled by follow-on processes or that creates multiple points of failures of fabricated components or reduced operational performance characteristics or expected usable lifespans. Copper for example melts at 1085° C. or 1358° K. Its recrystallization temperature is ˜0.4 Tm , where Tm is the melting point on absolute scale. This turns out to be 1358×0.4=543.2° K or 270.2° C. The recrystallisation temperature for steels is typically between 400 and 700° C. The kinetics of recrystallization were determined metallographically for stainless steel reacted over a range of strains at temperatures of 1600 to 2250° F. (860 to 1232° C.) at several strain rates, and annealed at temperatures of 1900 to 2250° F. (1037 to 1232° C.).

The preferred method of the present invention provides for thermal management within the fabrication machine to initiate and sustain thermal management to range from room temperature to above 2400 F (1315 C) for polymers, metals, ceramics and glass.

The preferred method of the present invention includes optimizing process parameters such as laser power, beam diameter, scan speed, hatch distance, material thickness and scan paths, which in turn directly affects fabrication process time, surface roughness, mechanical strength, dimensional accuracy, fabrication density and finally unit fabrication cost.

The preferred method provides for finite element analysis utilizing specific material-based parameters and/or artificial intelligence and/or variable input to a physics simulator to generate optimal rotation adjustments of a component to be fabricated in relationship to row placement for optimization of process time, mechanical strength, surface roughness, dimensional accuracy and unit fabrication cost. The preferred method of the present invention provides artificial intelligence via a physics simulator generating rotation adjustments of a component to be fabricated in relationship to row placement for optimization of process time, mechanical strength, surface roughness, dimensional accuracy and unit fabrication cost. The preferred method provides for finite element analysis utilizing set parameters and/or artificial intelligence and/or variable input to a physics simulator using one or a combination of to generate optimal x, y and z axis support for thickness and/or height. The preferred method of the present invention allows artificial intelligence and/or physics simulator and/or variable input using one of or a combination thereof to generate an optimal x, y and z axis support for thickness and/or height in relationship to row placement for optimization of process time, mechanical strength, surface roughness, dimensional accuracy and unit fabrication cost.

The preferred method of the present invention allow variable settings to generate Z axis raft and/or supports as base segment from the build plate to the first build object row. The preferred method of the present invention will allow the system to generate Z axis supports for next level up build object row and allow the generation of X & Y cross supports interconnects between Z axis supports between fabrication rows to provide X and Y rigidity and/or stability between Z axis supports of the additional fabricated object rows. The preferred method of the present invention allows optimal fabrication and stabilization of rows and columns from which to build objects with optimal fabrication layout and/or placement to load the printer bay full utilizing the entire mass volume of the build area to enable mass production of fabricated build objects. These Z axis support(s) and X & Y axis cross support(s) with adjustable variable support dimensions between fabrications allows adjustable fabrication scaling dimensions and/or mixing of multiple fabrication designs between fabrication rows which allows reduction of support material usage. The preferred method of the present invention provides for artificial build plates with the utilization of interlocking Z axis supports and/or rafts with the X axis and Y axis supports as a quasi-build plate between each row of fabrications. For example, fabrications with differing dimensions and/or weights can be placed in the same row by adjusting the height and thickness of Z axis supports and X & Y axis supports accordingly.

The preferred method of the present invention provides for adjustable spacing between rows of fabrication to allow optimal spacing for support material removal, for example mechanical cutter, waterjet and other methods.

The preferred method of the present invention provides for monitoring, analyzing and controlling the vacuum material for inventory management and/or material supply management.

Advantages of the preferred method of the present invention includes reduced structural supports and material requirements thereof when compared to typical prior art technologies.

The preferred method of the present invention provides of highly compacted layers via its ultrasonic leveling system performed during a spreader/recoater layer distribution processes.

The preferred method of the present invention provides for heat treatment with precipitation processes during the build with the benefit of higher density, greatly reduced thermal stress to materials, higher resistances, thermal characteristics that are unavailable and unobtainable with prior art methods and applications.

The preferred method of the present invention utilizes scalable fabrications with mass production capabilities that offer incorporating honeycomb and lattice design characteristics, which is a distinct novel advantage over prior art systems and provides for reduction of material usage by inclusion in all designs that can be enabled via weight reduction fabrication criteria of the targeted end component. The preferred method of the present invention provides mass production of honeycomb and lattice structure. The invention also provides for new designs and updates to older developments in both thermal and mechanic design, aircraft, light and heavy motor vehicle technology and light-weight construction, which have formed the basis for the past desired development of honeycomb and lattice structured panels.

The preferred method of the present invention builds upon its fabrication scaling with automation and vast material types to provide novel methods and applications that were previously limited or simply unavailable, not financially viable or even unmanufacturable with anything in prior art.

A primary advantage of the present invention is fabrications with low weight combined with great structural strength and industrial scaling of the design. Further, the present invention's design incorporating thermal control and gas management conserves energy and reduces gas input or gas generational requirements. The present invention allows for external gas storage, gas generation, thermal management, power systems, control systems, material supply, material separation and recycling and power systems.

Some advantages over prior art are due the current invention's heat treatment, densification, fabrication accuracy, and scaling to monetize fabrications. This is even more pronounced with honeycomb and lattice construction's light weight, high strength and anti-shock properties. The preferred method of the present invention provides for utilization of a honeycomb and lattice design with an internal facing, honeycomb and/or lattice core and external facing This design can be adapted to individual requirements, including but not limited to, strength and choice of materials to optimal performance and longevity, which is greatly enhanced when compared to prior art.

Prior art honeycomb and lattice structures are typically used as shock-absorbent structures both in mechanical and thermal fabrication and construction with characteristics attractive for use in fabrication; however, the prior art lacks cost effective mass production capability.

Methods and systems of the present invention are ideally suited compared to the prior art for design and architectural applications as a result of their optimal ratio of weight to load-bearing capacity and bending strength.

The preferred method of the present invention provides for automated scaled fabrication methods and applications and material utilizations, whereas the prior art lacked the ability to fully automate and provide cost effective scale of fabrication which lends to joints, welds fusions and mechanical connections which are reduced or eliminated by the systems and methods of the present invention.

The preferred method of the present invention provides high value aesthetic properties, including but not limited to, characteristics from transparent to translucent, visually attractive, catching the eye and directing the gaze. The versatile material fabrication method of the present invention can be tailor-made for a variety of design purposes.

The preferred method of the present invention provides better access for maintenance from reduced volume and weight when compared to typical prior art technologies.

The preferred method of the present invention having heat treatment during fabrication with no joints, welds or connections allows higher temperatures, higher pressures and higher margins of safety with lower costs, and maintenance with greatly extended useful life versus any prior art method and application. The preferred method of the present invention thereby allows cost effective fabrication of components, whereas with prior art processes, considerable material weaknesses contributed to a lesser product having lower quality and sometimes fabrication was not even feasible based on the cost, life span, or inability to fabricate or fabricate cost effectively.

The preferred method of the present invention utilizes a thermal management system to allow its high temperature build chamber to preheat the material to lower critical temperatures, reducing the thermal differential between melt temperature and solidification thereby reducing thermal stress related issues. The preferred method of the present invention allows thermal management to maintain build chamber temperatures ranging from room temperature up to 2800° F. This allows any polymer, metal, alloy, ceramic, cermet and other materials to be laser fabricated in a thermally controlled inert environment within the HDLS machine. Provided is a list of critical temperatures to consider preventing or reducing thermal induced defects. They are given in C and F temperatures. Plastics utilize just above room temperature to 600 F (315.55 C). Metals vary widely and when alloyed are highly dependent on the alloys, but typically utilize 400 F (204.44 C) to 2384 F (1306.66 C). Clays and ceramics utilize 100 F (37.78 C) to 2158 F (1181.11 C).

When materials are allowed to rapidly cool or must endure uncontrolled cooling as does many other materials, the deep thermal differential causes thermal stresses and micro fractures. The preferred method of the present invention performs heat treatment processes during and after the fabrication build through a maintained inert atmosphere and tightly controlled and moderated thermal management up to and including lower critical material temperatures. This offers precipitation hardening and/or tempering in a single integrated fabrication machine as part of a standard process.

The preferred method of the present invention will also allow a third beam movement to perform a retrace of the sintering beam path to perform material density enhancement, thereby increasing the density for strength, resistance and thus the quality for a reduced maintenance requirement and greatly extended life expectancy.

This method of the present invention provides for a stronger and more robust component fabrication versus any of the above or other known prior art methods by removing prior art methods and applications with distinct fabrication processes and archaic techniques and procedures of manufacturing having widely known weaknesses and limitations.

The preferred method of the present invention utilizes 3D object scanning for micrometer (μm or micron) accuracy level with real time analysis. This provides for the highest level of automated quality assurance and removal of potential material defects from the fabrication process before continuing, thereby not allowing a defect to go unrepaired. This presents a huge advantage and novel method versus prior art.

The preferred method of the present invention will also allow the integration with gantry based movable robotic direct metal deposition (DMD) to fill any voids or repair any flaws in the quadratic HDLS process layer. The preferred method of the present invention provides for DMD to also perform additional additive manufacturing allowing multiple additional material types to be fabricated by applying additional material types beyond the quadratic HDLS process targeted material within the quadratic HDLS build process. The preferred method of the present invention integration of DMD for example provides the ability to plate or coat with a higher resistant material or use copper to enhance the thermal transfer capability, which are novel in their own right and unavailable and not possible in or with prior art methods and applications thereof.

The preferred method of the present invention provides for reduced mass material fabrication of thermal and mechanical components as well as aircraft and spacecraft specific controlled mass material usage and strength design, whereas material mass is the biggest factor relating to efficiency and energy requirements. Prior art utilization motivated engineers to find viable methods to reduce material mass across as much of the design and development as possible. The initial effort was towards the components with the largest material mass. That was typically the structure associated with the system. Utilization of a design of sandwiched structures with supported voids such as a framed hexagon honeycomb core design promotes high structural strength and integrity while encouraging greatly reduced material mass usage. Therefore, the total weight of the system and/or component and material costs are both greatly reduced. Honeycomb cores typically consist of three parts: two plates or face sheets and an internal interlocking honeycomb wall core with mostly empty void space. The honeycomb core is an arrangement of thinly connected cells, typically using hexagons, which are sandwiched between the two plates or face sheets. The core provides typical strength of the structure, and the plates or face sheets provide the structural tensile strength. This light-weight design encompasses a large loading factor while keeping the structural material mass low. It should be noted however that the honeycomb structure is not thermal transfer or conduction efficient. The rationale is also what makes honeycomb structures attractive to engineers. Accordingly, high thermal loads do not transfer across the honeycomb structure efficiently for specific uses such as casings for steam turbines, CO2 turbines, pumps and compressors and other structures. The honeycomb structure is composed by mostly empty voids of space supported by interlocking wall structures. During thermal transfer, energy is communicated through the core It should be noted, however, that the thermal energy is communicated through the thin walls of honeycomb cells which have a very low thermal conductance ratio and, therefore, low thermal transfer capability. Thus, a very large temperature differential between the two plates or face sheets is required to communicate thermal energy. Additionally, due to the empty void space between the plates or face sheets, radiation thermal transfer is also a factor engineers must calculate into their design specifications. When radiation is compared to conduction, radiation is a poor way to communicate thermal energy, which is a factor that must be considered during design to determine the level of thermal energy communicated. Hence, calculations incorporating material type, conductance, and radiance must be factored in as necessary information during the design phase.

The preferred method of the present invention incorporates the ability to provide vacuum from the of the cartridge system to move smoke and gas contaminants away from the laser and material while promoting thermal exchange between the top layered surface and the previously fabricated layers.

For an oversimplification of the design process utilizing honeycomb structures, the following assumptions are typically used. First, the plate or face sheets of the panel are thin, so that the temperature differential through them is basically negligible. Second, there is no convection thermal transfer inside the panel, as the experiment will take place inside a still environment. Third, the cell walls of the core are thin so that the temperature gradient across them is negligible. Fourth, the thermal properties of the materials used do not change with the temperature. Fifth, the thermal effects of the connection between the honeycomb core and the plate or face sheets are considered negligible. And finally, the thermal energy transfer calculations are generally nonlinear due to the thermal radiation method.

The preferred method of the present invention provides for walls spaced with lattice structures that when sealed can provide vacuum based insulation, and using the present invention, HDLS would provide the ability for cost effective mass production.

The preferred method of the present invention provides the novel ability to use finite element analysis to give the strongest design of all possible design choices. This method of the present invention provides for honeycomb design customized designs for Hexagonal, Reinforced Hexagonal, Over-Expanded Hex Core, Flexible Hex Core, Double Flexible Hex Core, Spiral wrapped (tubular-core), Criss-Cross-Hex-Core, hybrid Flower-Circular (tubular, flower core) and Square formed honeycomb orientation.

Another advantage of the current invention over the prior art is reduced floor space for the component and when attached to a skid with the present invention's enhanced reduction in volume and/or in weight, a stackable skid installation arrangement is possible.

The preferred method of the present invention provides for an integral process including the inclusion of 3D object scanning, and/or thermal and/or visual scanning of the fabricated component for errors in fabrication This provides for integration of a gantry to provide mounting for a Direct Material Deposition system. The prior art has two different versions of typical DMD processes, those providing for manual and automatic modes. Semi-Manual laser deposition welding: In the case of manual deposition welding, the welder guides the filler material “by hand” to the area to be welded. An automatic fed thin wire with a diameter between 0.15 and 0.6 millimeters is primarily used as filler material in this process. The laser beam melts the wire. The molten material forms a strong bond with the substrate, which is also melted, and then solidifies, leaving behind a small, raised area. The welder continues in this fashion, spot by spot, line by line, and layer by layer, until the desired shape is achieved. Automated laser deposition welding: In the case of automated deposition welding, the machine guides the filler material to the area to be welded. Although the material can also be a wire, this process primarily uses metal powders. Metal powder is applied in layers to a base material and fused to the base material and is fused to it without pores or cracks. The metal powder forms a high-tensile weld joint with the surface. After cooling, a metal layer develops that can be machined mechanically. A strength of this process is that it can be used to build up a number of similar or differing metal layers.

Inert gas, including but not limited to inert or noble gas, rare gas, argon, any of the chemically inert gaseous elements of the helium group in the periodic table, or the unreactive gaseous elements helium, neon, argon, krypton, xenon, and radon and which can include carbon dioxide to also include nitrogen gas for certain uses as the gas shields for work process barrier to ambient air. Finally, the part is restored to its original shape by grinding, lathing, milling, EDM etc.

The preferred method of the present invention with integration of quadratic with cnc automated DMD can provide a near flawless expansion of originating quadratic HDLS build with DMD based laser cladding to enhance the original material for higher resistance and wear. Furthermore, the preferred method of the present invention with integration of quadratic with cnc automated tools for machining and milling any potential flaws during the build cycle with availability of DMD enabled repair of the flawed area which can provide a near flawless expansion of originating quadratic HDLS build.

The preferred method of the present invention introduces a unique 90-degree mirror offset arrangement and dynamic focus module which allows for the laser, focus system, galvo scanner, and camera system(s) to enable tightly packed typically laser galvo assemblies allowing high density laser configurations. Alternatively, a camera can be mounted next to the galvo assembly to image or provide thermography of the build surface. The preferred method of the present invention provides for a laser based Stereolithography system consisting of laser with galvos, z axis with height adjustment mechanism, recoater, drive mechanism for recoater movements, resin tank and other typical components of Stereolithography machines.

The preferred method of the present invention may alternatively utilize gas tight doors and ducting valves with a vacuum system to evacuate contaminate gases from the build chamber in preparation for containment gas insertion into the Stereolithography build chamber environment to avoid atmospheric gas and moisture exposure.

The preferred method of the present invention provides for a recoater arm assembly, preferably to mount a height sensor. The preferred method of the present invention provides for a recoater arm height adjustor mechanism for height adjustment of the recoater or wiper assembly.

The preferred method of the present invention provides for a bearing for movement of the recoater across the build area to recoat the build plate, preferably with the build plate lowered into the resin to recoat the build plate and then raised to allow removal of excess material.

The preferred method of the present invention will alternatively utilize a Cartesian mount with a drive mechanism on the same side.

The preferred method of the present invention will allow for automated opening and closing of the access door for sealing of gases or fumes in or out of the machine and for install or removal of the build plate. The preferred method of the present invention will provide for ducting of the fumes within the machine.

The preferred method of the present invention will allow storage and processing of resin within the machine and offer access panels for maintenance of the machine.

The preferred method of the present invention provides for a build plate assembly to mount a jack plate. The preferred method of the present invention provides for a jack plate that mounts a removable build plate. The preferred method of the present invention provides for automation of a Stereolithography machine with a removable build plate with jack openings near the bottom for insertion of forklift. The preferred method of the present invention for automated Stereolithography machine operation allows insertion or extraction of the build plate assembly automated doors and utilizing a fork stacker device for insertion or extraction of the build platform.

The preferred method of the present invention provides for a resin removal tank preferably with venturi mixer nozzle(s). Preferably, the nozzle(s) flows from a resin remover liquid circulation pump to remove the excess resin from the inserted fabrication. The preferred method of the present invention provides for the fork stacker device to insert and remove the build plate from the excess removal tank.

The preferred method of the present invention utilizes a cartridge or build module system for component builds within the HDLS machine and for insertion or extraction for transfer to further processes. The preferred method of the present invention provides for the build module to allow placement of forms to form channels, the channels will allow custom shaped build platform plates and lift mechanism. The preferred method of the present invention provides for the build module to allow for various build area shapes such as square, round, rectangle, triangle and any geometrical shape. The preferred method of the present invention provides for the build module to allow placement of forms to form channels. The channels will allow custom shaped build platform plates and at least one lift mechanism to enable building of vertically built straight and curved plates, square tanks, oval tanks and round tanks. The preferred method of the present invention provides for the fabrications to fabricate with honeycomb and lattice construction while reducing the power required due to the reduced build area provided by using the forms and build chamber channels.

The preferred method of the present invention utilizes a build module to be mounted on a carriage and wheels, which is in set on track for movement in and out of the fabrication system and/or following processes. Alternatively, the preferred method of the present invention may use skids, wheels or rollers attached to the bottom of the unit to provide build module movement and alignment in and out of the unit. The preferred system of the present invention utilizes mechanical insertion and extraction from a drive mechanism into the build module to active the lift mechanism. The preferred system of the present invention utilizes mechanical insertion and extraction of said drive mechanism from a motor to facilitate up and down movement of the build assembly inside the portable build module. The preferred method of the present invention alternatively provides for the lift drive mechanism to be mounted below the build module. The preferred method of the present invention alternatively provides for the lift system to move from the side of the build module to beneath the build module to enable custom forms for a build area with special fabrication shapes, such as round or oval fabrications. This may require the lift mechanism and/or the lift drive system to be mounted below the build module.

The preferred method of the present invention provides for a capture area below the build module while inserted into the machine to provide a method for capture of potential loose powder. The preferred method of the present invention alternatively provides for the capture area to include a method for provisioning a duct for vacuum of loose powder. The preferred method of the present invention alternatively provides for the capture area to include a method of provisioning a duct for airflow to promote thermal management.

The preferred method of the present invention alternatively provides for the lift system in its entirety to be placed in subflooring below the build module, as this will avoid excessive machine height.

The preferred method of the present invention includes integration of at least one robotic thermal spraying cell. This may include coating processes in which melted (or heated) materials are sprayed onto a surface. The “feedstock” (coating precursor) is heated by electrical (plasma or arc) or chemical means (combustion flame). Thermal spraying can provide thick coatings (approx. thickness range is 20 micrometers to several mm, depending on the process and feedstock) over a large area at high deposition rate as compared to other coating processes such as electroplating, physical and chemical vapor deposition. Coating materials available for thermal spraying include, but are not limited to, metals, alloys, ceramics, plastics and composites. Thermal spraying typically feeds materials in powder or wire form, heated to a molten or semi molten state and accelerated towards substrates in the form of micrometer-size particles. Combustion or electrical arc discharge are usually used as the source of energy for thermal spraying. Resultant coatings are formed by the accumulation of numerous sprayed particles. The targeted surface generally does not heat up significantly, allowing the coating of flammable substances and plastics without excessive deforming the target surface or the shape of the target. Thermal spray coating quality is usually assessed by measuring its porosity, oxide content, macro and micro-hardness, bond strength and surface roughness. Generally, the coating quality increases with increasing particle velocities.

Several variations of thermal spraying are distinguished: plasma spraying, detonation spraying, wire arc spraying, flame spraying, high velocity oxy-fuel coating spraying (HVOF), high velocity air fuel (HVAF), warm spraying, cold spraying techniques. Plasma spraying, developed in the 1970s, uses a high-temperature plasma jet generated by arc discharge with typical temperatures >15000 K, which makes it possible to spray refractory materials such as ceramics, oxides, molybdenum, etc. Thermal spraying is an industrial coating process that consists of a heat source (flame or other) and a coating material in a powder or wire form which is literally melted into tiny droplets and sprayed onto surfaces at high velocity. This “spray welding” process is known by many names including Plasma Spray, HVOF, Arc Plating, Arc Spray, Flame Spray, and Metalizing.

Thermal sprayed coatings are typically applied to metal substrates but can also be applied to some plastic substrates. Thermal sprayed coatings uniquely enhance and improve the performance of the component. Substrates can be most metals including: aluminum, steel, stainless steel, copper, bronze and some plastics.

Plasma spray is the most versatile of the thermal spray processes. Plasma is capable of spraying all metallic and nonmetallic materials that are considered sprayable. In plasma spray devices, an arc is formed in between two electrodes in a plasma forming gas, which usually consists of either argon/hydrogen or argon/helium. As the plasma gas is heated by the arc, it expands and is accelerated through a shaped nozzle, creating velocities up to Mach 2. The highest velocity possible is desired. Temperatures in the arc zone approach 36,000° F. (20,000° K). Temperatures in the plasma jet are still 18,000° F. (10,000° K) several centimeters form the exit of the nozzle.

Thermal sprayed coatings can be an effective alternative to several surface treatments including: nickel and chrome plating, nitride or heat treat processes, anodizing, and weld overlay. They are typically thicker than plating, in the range of 0.002″-0.025″ thick depending on the coating material.

Nozzle designs and flexibility of powder injection schemes, along with the ability to generate very high process temperatures, enables plasma spraying to utilize a wide range of coatings. The range goes from low melting point polymers such as nylon, to very high temperature melting materials such as refractory materials including tungsten carbides, stainless steels, ceramics (chrome oxide, aluminum oxide, zirconia, titania), nickel-chrome carbides, pure metals (aluminum, zinc, copper), tungsten, tantalum, ceramic oxides, and other refractory materials.

Because plasma-arc spraying is the most versatile of all the thermal spray processes it can be found in the widest range of industries. Plasma spray coatings are used commonly for applications in aerospace, automotive, medical devices, agriculture communication, etc. Jet engines contain hundreds of components that are plasma spray coated. A commonly used coating in jet engines is produced with yttria partially stabilized zirconia (YSZ). This coating provides high temperature protection to components that are exposed to combustion gases and/or supercritical fluids. The thermal protection allows the component to last longer and run at higher temperatures, which improves the system's overall performance efficiency.

The four primary spray methods commonly used today are Electric Arc Spray (twin wire electric arc), Flame Spray (Oxy-acetylene), Plasma Spray (APS), HVOF (High Velocity Oxy-Fuel).

Electric wire arc thermal spraying utilizes the same principles employed in wire arc welding systems. The coating material, in wire form, is electrically charged, and then contacted creating an arc. The molten droplets of metal wire are then sprayed onto the substrate using a high velocity air stream to atomize and propel the material.

Plasma Arc spray coatings are very cost effective and are typically used to apply metals like pure aluminum, zinc, copper, and metal alloys such as stainless steel. Arc spray also allows adjustments to achieve varied coating texture (200 micro inches-800 micro inches).

Flame spray, also known as oxy/acetylene combustion spray is the original thermal spray technique and was developed roughly 100 years ago. It uses the basic principles of a welding torch with the addition of a high velocity air stream to propel molten particles onto the substrate. The coating material can be either a wire or powder form. Often flame spray coatings are fused after being applied to enhance bond strengths and coating density.

The plasma spray process (non-transferred arc) uses inert gases and/or supercritical fluids fed past an electrode inducing the “plasma” state of the gases and/or supercritical fluids. When the gases and/or supercritical fluids exit the nozzle of the gun apparatus and return to their normal state, a tremendous amount of heat is released. A powdered coating material is injected into the plasma “flame” and propelled onto the substrate. Ceramic Coatings are most often applied using plasma spray due to their high melting temperatures. (Often >3500 F). Several types of ceramic coatings can be applied using plasma spray.

The HVOF (High Velocity Oxy-Fuel) process combusts oxygen and one of select group of ignitable gases and/or supercritical fluids including: propane, propylene, or hydrogen. Although the HVOF system uses the basic principle of combustion, the spray gun is designed differently than the standard oxy-fuel spray gun. The HVOF gun differences produce higher flame temperatures and higher velocities. The result is more thoroughly melted powder and more kinetic energy available to “flatten” the molten particles of coating material. The HVOF process produces superior bond strength and coating density. The HVOF process is most often used to apply high melting temperature metals and metal alloys such as: tungsten carbide, nickel, Inconel, chrome carbide.

The preferred method of the present invention with integration of robotic DMD can provide an enclosed controlled environment for near flawless capability of joining two quadratic HDLS fabricated component pieces into a larger single component. The preferred method of the present invention with integration of automated friction stir welding can provide a near flawless capability of joining two quadratic HDLS fabricated component pieces into a larger single component.

For example, CNC or robotic operated DMD or friction stir welding can be done to minimize changes in material properties thereby maintaining targeted pressure, temperature and tensile strength properties and characteristics which can be selected dependent on the targeted resultant component operational requirements. Another example of an automated and amalgamated process would be with quadratic fabrication of the ends of a tank and its cylinder segments and with CNC and/or robotic controlled DMD and/or frictional stir welding to join the components as separate single fabricated components into a singular large assembled component.

The preferred method of the present invention with lower build chamber temperatures with follow up heat treatment and integration of DMD can provide for changes in design in real-time or for any potential flaws, errors in the initial quadratic HDLS sintering process layer. The preferred method of the present invention with lower build chamber temperatures with follow up heat treatment and integration of direct metal deposition (DMD) provides for an enhanced set of integrated processes of advanced additive manufacturing technology used to repair and rebuild worn or damaged components, to manufacture new components, and to apply wear- and corrosion resistant coatings. DMD produces fully dense, functional metal parts directly from CAD data by depositing metal powders pixel-by-pixel using direct laser sintering

The preferred method of the present invention provides for an artificial intelligence decision-based feedback control system, 3D object scanning, and thermal and visual scanning to maintain highly precise dimensional accuracy and material integrity. With the feedback system, 3D object scanning, thermal and visual scanning, artificial intelligence and machine learning, seven-axis deposition tool, and multiple material delivery capability, DMD can coat, build, and rebuild parts having extremely very complex geometries with submicron accuracies.

The preferred method of the present invention provides for automation of complex fabrication and complex protective coatings for cost effective yet high quality fabrication, whereas prior art fabrication, manufacturing and design capabilities thereof is limited in quality, quantity, costs, timeframes and competitiveness when compared to the present invention's novel methods, applications and fabrication with associated manufacturing competitive advantages and high value offerings.

The present invention provides for fabrication of components and devices that prior art processes are not capable of or for which the prior art processes have limited capacity or are not competitive due to its all the above and commonly known limitations in comparison to the applications and fabrication methods of the present invention.

The preferred method of the present invention utilizes one or more cameras and an imaging system to provide images and thermography of the build area for analysis as well as a magnified area with transfer and storage of data as input to artificial intelligence processes Additionally these 2d camera views can then be compared to the data of the 3d slices for monitoring, analysis, and control. This data, for example, can expose surface anomalies for the laser to retrace to smooth and/or fix the surface error.

The preferred method of the present invention utilizes multiple axis mirror galvo(s) to direct the laser beam for fusing the layers of powder. The preferred method of the present invention utilizes a mirror galvo(s) system with beam splitters to enable the one or more cameras and imaging system having at least one motorized course and/or motorized fine focus optical adjustments. Furthermore, the mirror galvo(s) system with beam splitters enables the system to provide images and thermography of the melt pool for analysis and a magnified area with transfer and storage of data for input to the artificial intelligence processes. The preferred method of the present invention may also rely on the galvo based camera imaging with its amplified view system utilizing motorized course and/or motorized fine focus adjustment to inspect the now magnified area for surface errors and anomalies, possibly to instruct the system to retrace the area with the laser to remelt and or repair the voids or other surface errors. Moreover, the preferred method of the present invention utilizes the mirror galvo(s) system with beam splitters to enable the one or more cameras and imaging system utilizing motorized course and/or motorized fine focus adjustment to provide images and thermography of the magnified view of build area near the beam melt pool for analysis as well as magnified area with transfer and storage of data as input to artificial intelligence processes.

In addition, the preferred method of the present invention utilizes the mirror galvo(s) system with beam splitter to enable the one or more cameras and imaging system utilizing motorized course and/or motorized fine focus adjustment of the beam diameter and/or its on/off status and timing thereof for the purpose of analysis, transfer and storage of data as input to an artificial intelligence processes

The preferred method of the present invention provides for a galvo assembly consisting primarily of x and y mirrors with galvos motor assemblies, servo or stepper motors for fine and/or course adjustments, camera connections, alternatively provides gas and liquid cooling. The preferred method of the present invention allows for input and output ducts to allow cooling flow between the galvo modules and the optical barrier assembly. The preferred method of the present invention provides for a galvo controller to control the galvo assembly and laser power. The preferred method of the present invention provides for a galvo module to consist of a galvo assembly, laser head and alternatively include the galvo controller. The preferred method of the present invention allows the galvo module to utilize gas and/or liquid cooling. The preferred system will offer the 3d image converted into 2d scans and divided into quadrants to be sent to the galvo assemblies for laser fusing the objects in the data This data can therefore be used to compare with camera or imaging for feature accuracy and for object comparison for accuracy and/or basis for correction.

The preferred method of the present invention allows for mounting of cameras to the recoater assembly for analysis and monitoring of the build area. Preferably, the camera's data will be stored and/or compared for artificial intelligence training and/or system optimization.

The preferred method of the present invention utilizes flows of independent gas flows to perform thermal management to areas of the system.

The preferred method of the present invention utilizes optical thermal barrier and preferably utilizes antireflective coatings for optimal operation.

The preferred method of the present invention utilizes gas and/or liquid cooling to provide thermal management.

The preferred method of the present invention may provide a powder removal station to utilize robotics with an end effector to perform powder removal with a vacuum system and/or blow with a nozzle of pressurized gas flows. The preferred method of the present invention provides a method for managing the build module to enable the module to raise the build platform to remove said powder.

The preferred method of the present invention provides a method for movement of the build module to a station for removal or insertion of a build plate.

The preferred method of the present invention provides for a material movement system such as an overhead crane or transfer system to transfer a build plate to a mobile transporter. Further, the preferred method of the present invention provides for a material movement system such as an overhead crane or transfer system to enable build plates, parts or other materials needed to be moved around the facility to enable installs, removals, maintenance or repairs.

The preferred method of the present invention provides for a control system to communicate to electronic devices such as computers, microcontrollers and logic systems to monitor, analyze and control said electronic devices. The preferred method of the present invention provides for the control system to transfer information to and from stations within the system to control operation, monitoring and analysis. The preferred method of the present invention provides for a computer and/or network of computers connected to and/or as part of the control system to communicate data to and from stations of the fabrication system to monitor, analyze and control the stations within the fabrication system. In the preferred method of the present invention, the control system synchronizes the operations of said stations.

The preferred method of the present invention provides data for project costings and incomes. The preferred method of the present invention provides for data to utilize with simulations for estimated and actual build time, process time and idle time.

The preferred method of the present invention may provide a transfer and resin removal station preferably with ducting of gases for capture, separation and disposal.

The present invention provides for a lift system to transfer to and from the build plate to the resin removal tank insert and extract allowing transfer to the next station.

The first process after HDLS fabrication comprises removal of excess unfused material which has its process comprised for material removal via a robotic arm with an attached vacuum system utilizing data used to form the component utilized for movement of the material removal process via analysis of 3D space mapping of unfused material space within the build cartridge thereby leaving only the targeted fused components of intended work fabricated with the HDLS process.

The preferred method of the present invention provides for a powder transfer method to transfer powder to a powder loading system. Preferably, the powder transfer uses vacuum transfer of powder to the top of machine with a metered canister having a valve at the bottom. This allows transfer of powder into the machine from storage. Alternatively, the powder loading system will use gas flow to clean the filter that protects the vacuum system during transfer operation to load the canister from pulling powder into the vacuum system. The preferred method of the present invention will utilize a storage bin that receives metered power from a canister above the machine.

The preferred method of the present invention will utilize a metering system to fill the hopper of the spreader/recoater assembly. The preferred method of the present invention will utilize capture bins on each side of the build chamber to capture excess power from the spreader/recoater assembly. The preferred method of the present invention may utilize the capture bins to empty the spreader/recoater. The preferred method of the present invention may utilize capture bins with outlets for use with vacuum transfer of powers out of the machine.

The preferred method of the present invention provides for mechanical transfer or motorized movement of the spreader/recoater assembly with thermal isolation of the drive system and the motor from the build chamber thermal energy. The preferred method of the present invention provides for mechanical transfer of motorized movement of the spreader/recoater assembly.

The preferred method of the present invention provides for heating and cooling of the build chamber, preferably utilizing insulation inside the machine.

The preferred method of the present invention will utilize separate heating and cooling systems to moderate independent thermal management. Alternatively, the invention may utilize a single heating and cooling system to moderate thermal management. The preferred method of the present invention will utilize ducting for gas flow heating and cooling. The preferred method of the present invention will utilize ducts mounted at the top of the machine for flow down to the build area. The preferred method of the present invention will utilize knife-edge and/or regular ducting for flow across the optical barrier, alternative the opposing side duct will use an educator to pull flow across the optical barrier surface.

The preferred method of the present invention provides for eXtended Reality, Virtual Reality or Augmented Reality or Mixed Reality to train and sync the robotics and automation between cells including removal of fabrications from the printer.

The preferred method of the present invention incorporates sonic and/or ultrasonic transducer(s) connected to the spreader/recoater assembly for leveling and compacting of material layers. The preferred method of the present invention incorporates sonic transducer injecting signal within wave guide(s) to targeting reflector(s) to align the sonic waves at the targeted material layer. Additionally, the sonic transducer and preferably the wave guide(s) and reflector(s) are connected to the spreader/recoater assembly for leveling of layered material and/or compacting of material layers.

The preferred method of the present invention provides for connections of the sonic leveling system components that are preferably isolated via vibration separation technology for optimal sonic energy transfer. Alternatively, the invention may include mechanical connection of the spreader/recoater assembly during refills to remove voids in the powder to be applied during recoating.

The preferred method of the present invention features vibration isolation and thermal separation to allow the sonic energy to be generated and transferred inside the build chamber for optimal operation and avoid damage to the transducer from excessive thermal energy.

The preferred method of the present invention incorporates at least one sonic transducer injecting signal within a transmission medium, which is typically a rod, bar or square to transfer the sonic waves to the targeted material layer. Additionally, the sonic transducer, wave guide(s) and reflector(s) may be connected to the spreader for leveling of layered material and/or compaction of material layers. The preferred method of the present invention creates a method for thermal separation of build area and the ultrasonic transducer area to promote adequate cooling of the transducer.

The preferred method of the present invention provides for lift points on the build plate. The preferred method of the present invention provides for lift points on the support and/or transfer plate.

The preferred method of the present invention provides for the use of a computer and/or network system to control system, processes and applications. The preferred method of the present invention provides for data communications to and from each section of the system and to administer control of said section.

The preferred method of the present invention allows integration of multiple gantry-based systems. This allows gantry based application integrating powder bed and/or powder bed and DMD fused layers with integration potential for additional additive manufacturing methods. It further allows gantry based application integrating FDM (Fused Deposition Modeling, DMD (Direct Material Deposition) fused layers to the power bed fused and power bed and DMD fused layers which comprises multiple additive manufacturing technologies into a single cohesive solution. The preferred method of the present invention allows integration of multiple gantry systems; this allows integration of CFF continuous fiber fabrication head with FDM or DMD fused application layer thereby allows four unique additive manufacturing techniques incorporated into a single amalgamated solution as a symbiotic fabrication system. CFF or FFF Head on the lower gantry system allows FFF Head for either FDM or DMD polymer fused deposition or CFF Head-Fiber Cord/Wire (continuous carbon fiber, Kevlar etc) application with FDM or DMD fused bonding.

The preferred method of the present invention may utilize an enclosed system utilizing door(s) to enclose the area for capture of loose or floating particles during excess material removal.

This process may utilize the 3D data from the initial HDLS component build which forms the model the HDLS system uses to fuse the layers of materials into targeted objects. This allows the excess material removal to use the data to form 3D space in which to move a robotic arm with a vacuum system to remove the excess material without hitting or causing damage to the completed fused components.

The preferred method of the present invention utilizing the previous automated step with excess materials removed to then transfer the cartridge or build module and its contents in which the robotic next station allows removal of the build plate and fused components from the cartridge.

This process utilizes a crane and or lift system to place the build plate and fused components onto a carrier and/or cart and/or carriage. This will allow movement to additional stages and steps with corresponding processes. The preferred method of the present invention provides a method for the transfer of the fabrications using an automated transport to the hot isostatic pressing system and for removal of same. The preferred method of the present invention provides for a method of automated transfer and loading and unloading of fabrications from said hot isostatic pressing system.

The preferred method of the present invention provides for 3d printing of said isostatic pressing system with heating and/or cooling and gas pressurization and allowing automated loading and unloading of fabrications.

The preferred method of the present invention provides for thermal and gas seals for doors and access panels. The preferred method of the present invention provides for gas supply and regulation into the machine. The preferred method of the present invention provides for vacuum of the chamber to remove atmospheric gas contaminations. The preferred method of the present invention provides for evacuation of containment gas(es). The preferred method of the present invention provides for separation and purification of gases and removal of contamination gas(es) for reuse. The preferred method of the present invention provides for the input of a gas mixture, preferably a mixture of noble gases with cost efficient argon and thermal effective helium for its superior thermal conductivity to optimize thermal input, transfer and removal.

The preferred method of the present invention provides for automated vacuum movement of materials with vacuum, valves, storage container to enable transfer between processes, the preferred method will additionally utilize a gas flow purge to clean the filter.

The preferred method of the present invention provides for melting of raw or recycled material, atomization of material in to power, separation and grading of material particle size and storage of powdered material, which can then be transferred to father processes or separations utilizing argon gas for containment and vacuum for powder movement.

Thermal energy or a drying function may be used to remove moisture and/or gas separators to remove contaminate gases.

The preferred method will use noble gases to provide containment from atmospheric gas and moisture and oxidation.

The preferred method of the present invention may utilize a spectroscope for material analysis. The preferred method of the present invention may utilize a spectroscope for detection of foreign unapproved materials.

The preferred method of the present invention may utilize a cyclone separation device to separate the larger particles from the smaller particles to optimize the particle sizing processes.

The preferred methods of the present invention provides for a gas tight automated sieve with functions of motorized rotating vibration units that may have openings that allow insertion or removal of weights to enable timing, frequency and amplitude of optimal vibrations for specifically size and weight of materials for optimal sieved material separation.

The preferred method of the present invention provides means for automated transfer of fabrications between steps may consist of automated or manual build plate and fused component separation which may comprise CNC based tool finishing, polishing, coating and spraying, handling to other robotic cells and processes.

The preferred method of the present invention allows automated transport to transfer fabrication and locking support plate into place below the isostatic pressing system for lift into the system for isostatic pressing system functions and removal thereof.

The preferred method of the present invention provides for 3d fabrication and build of low temp, warm temperature, water based and high temperature isostatic pressure vessel manufacturing.

The preferred method of the present invention provides for the method for transport to and from the isostatic pressing system. The preferred method of the present invention provides for the method of loading and unloading the isostatic pressing system using a lift system. The isostatic pressing system will integrate with the control system for operation, including locking and unlocking of the locking mechanism for loading and unloading of the isostatic pressing machine.

The mobile transport is the last stage for transfer of the fabricated components to additional processing or for handling to ready for processing by transporting for handling and shipping such as processing into boxes, cartons and paleting.

These methods and processes will allow focus on high performance components and mass production while targeting sustainability and cost effectiveness. With fabrications extending to on demand rapid tool creation of small to very large molds, castings and dies thereby allowing onsite optimized mass production of castings, extrusions and stampings. The system would also enable more lasers for faster builds and fabrications for special purposes or timely fabrication requirements. The system is the only powder bed system-based system with multiple material build and repair capabilities during build time.

A large market exists support the above components. Targeted is the thermal component market of full scale, mass production and up to utility class utilization of exotic/non-exotic materials in extreme high pressure to low pressure and high temperature to low temperatures heat exchangers, boilers, steam generator and recuperators and other thermal components with the highest efficiencies and surface densities utilizing micro channels except the components would have no weld joints or mechanical linkage for assembly. HDLS would allow casings and other components to incorporate all forms of honeycomb construction to reduce material usage and excess mass thereby greatly reducing weight.

The invention integrates automated mass production scale additive technologies like a Hybrid Direct Laser Sintering (Hybrid DMLS/SLS) system, Direct Material Deposition (DMD), Fused Deposition Modeling (FDM) and Stereolithography (SLA) with modern fabrication methods such as casting molding, dies, jigs, fixtures, injection, pressing, welding and plating. Integrating automated hybrid subtractive manufacturing technologies such as Plasma or Water cutter, Electrical Discharge Machining (EDM), machining, lathe and other methods.

The system utilizes at least one artificial intelligence system to monitor, analyze and control the robotic automation of the entire precision driven system for very robust fabrication and manufacturing in a monolithic factory lights out automated manufacturing setting. Optimizing design through shipment processes to provide stress free automated manufacturing with robotics handling and processing.

Features of the invention may include one or more of: AI operated Multiple robotics based gantry-based architecture, AI operated SLS 60 w, 80 w, DMLS 400 w, 500 w, 700 w and 1 kW laser setups, AI operated High density laser arrays with up to 256 sintering beams, AI operated 3D 3 Axis galvo scanners w/laser beam width lens focus control, AI operated Auto material distribution and auto material leveler, AI operated 360° thermal managements for all print and build areas, AI operated 3D multimode object scanning for active build area monitoring, AI operated Robotic DMD engaged active repair of build surface errors, AI operated Industry leading feature resolution and beam focus system, AI operated Gas management and material processing and recycling, AI operated Integrated heat treatment and aging functions, AI operated Automated build plate provision system, AI operated Robotic automated material and component handling, AI operated Machine learning for operations and health monitoring.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

1. A modular system for automated fabrication comprising:
a. a material management module;
b. a build module including 3D printing module;
c. an automation module;
d. a control module for integrating said modules with each other.

2. The system of claim 1 wherein said 3D printing module is a hybrid direct laser sintering 3D printing process module.

3. The system of claim 1 wherein said material management module manages at least one of new material, recycled material, and waste material.

4. The system of claim 3 wherein said material management module manages at least two of new material, recycled material, and waste material.

5. The system of claim 4 wherein said control module is a cloud-based system.

6. The system of claim 5 wherein said control module includes monitor, analysis, accounting, and control modules.

7. The system of claim 6 wherein at least one of said modules includes an artificial intelligence module.

8. The system of claim 2 wherein said hybrid direct laser sintering 3D printing process module includes a select laser sintering module and a quadratic direct metal laser sintering module.

9. The system of claim 8 wherein said hybrid direct laser sintering 3D printing process module further includes at least one scanner.

10. The system of claim 9 wherein said scanner is selected from the list consisting of a 3D object scanner, a thermal scanner, and a visual scanner.

11. The system of claim 10 comprising all of said 3D object scanner, thermal scanner, and visual scanner.

12. The system of claim 7 wherein two or more systems located across a geographic distance contribute to a single machine learning module of said artificial intelligence module.

13. The system of claim 1 wherein said build module include at least one of a heater, insulation, and a water jacket.

14. The system of claim 1 further comprising a transport module.

15. The system of claim 1 wherein the system includes a self-contained cartridge system.

16. The system of claim 1 further comprising at least one of a mechanical lift system, vacuum ducting, gas supply ducting, and a material capture tray.

17. The system of claim 1 further comprising a finite element analysis module.

18. They system of claim 1 further comprising a recoater module.

19. The system of claim 1 including one or more computers connected to each module, said one or more computers communicating with each other to comprise said control module.

20. The system of claim 1 wherein one or more modules includes robotics.

21. The system of claim 1 further including an ultrasonic imagining and leveling module.
